(19) United States
(12) Patent Application Publication
(10) Pub. No.: US 2026/0266026 A1
(43) Pub. Date: Sep. 10, 2026

(54) ELECTRIC WORK MACHINE WITH ENERGY RECOVERY

(71) Applicant: Caterpillar Inc., Peoria, IL (US)

(72) Inventors: Andrew Richard CAWDERY, Stamford (GB); Corey Lee GORMAN, Peoria, IL (US); Eric W. CLER, Oswego, IL (US); Ryan P. MCENANEY, Clayton, NC (US)

(21) Appl. No.: 19/168,454

(22) PCT Filed: Feb. 21, 2024
(86) PCT No.: PCT/US2024/016596

§ 371 Date: Sep. 24, 2025

(30) Foreign Application Priority Data
Mar. 27, 2023 (GB) 2304459.7

(51) Int. Cl. E02F 9/20; B60L 1/00; B60L 1/02; B60L 55/00; E02F 3/38; E02F 3/42

(52) U.S. Cl. CPC E02F 9/2091; B60L 1/003; B60L 1/02; B60L 1/20; B60L 55/00; E02F 3/38; E02F 3/425; E02F 3/427; E02F 9/2095

(57) ABSTRACT

An electric work machine comprises a boom and an electromechanical actuator. The boom comprises a bifurcated portion comprising two legs. The electromechanical actuator is connected between the boom and a mount in a plane normal to an axis of rotation of the boom about a mount-actuator pivot, wherein the plane extends between the two legs of the of the boom and wherein the electromechanical actuator is configured to extend and contract so as to effect rotation of the boom with respect a mount-boom pivot. The electric work machine further comprises a controller configured to control distribution of a quantity of energy recovered by the electromechanical actuator to one or more of: an electric storage assembly comprising the electric storage device; one or more subsidiary electromechanical actuators; and a load dissipator.

### FIELD OF THE DISCLOSURE

The disclosure relates to the field of electric work machines. In particular, the disclosure relates to electric work machines which make use of electromechanical actuators to control a position of a boom.

### BACKGROUND

Work machines, such as excavators, mini-excavators, backhoes, and the like, may comprise a boom which is attached to the work machine chassis at a pivot point. Actuators, typically hydraulic actuators, are connected between the boom and the chassis in order to control the boom position.

Electric work machines may use electromechanical actuators to control the boom position. Electromechanical actuators may be larger and/or bulkier than hydraulic actuators for providing an equivalent force.

U.S. Pat. No. 3,902,295 A discloses an excavator boom for an excavator.

The boom is pivotably connected to the chassis at a pivot point. A pair of linear hydraulic actuators are pivotably each connected to an apex of the boom on opposing sides of the boom. As such, the boom of U.S. Pat. No. 3,902,295 A is located between the pair of hydraulic linear actuators.

U.S. Pat. No. 3,376,984 A discloses a typical arrangement for a boom and a pair of hydraulic linear actuators for a backhoe. In U.S. Pat. No. 3,376,984 A, the boom is pivotably connected to a chassis at a pivot point. A pair of hydraulic linear actuators are connected between the chassis and the boom at either end of the pivot. As such, the boom of U.S. Pat. No. 3,376,984 A is located between the pair of hydraulic linear actuators.

U.S. Pat. No. 4,074,821 B discloses an arrangement for a backhoe wherein the boom comprises a pair of transversely spaced apart boom sections, each boom section pivotably connected to the chassis. A single boom hydraulic linear actuator is then mounted between the boom sections.

Against this background, the present disclosure seeks to provide an improved boom assembly, or at least a commercially useful alternative thereto.

### SUMMARY OF THE DISCLOSURE

Against this background, in a first aspect there is provided an electric work machine comprising:
a work machine body comprising an electric storage device; and
a boom assembly comprising a mount, a boom and an electromechanical actuator, the mount being connected to the work machine body;
wherein the boom comprises:
an upper end configured to be connected to an arm;
a lower end that is pivotably connected to the mount about a mount-boom pivot;
an actuator attachment point located between the upper end and the lower end of the boom;
a bifurcated portion of the boom comprising two legs, the bifurcated portion extending between the actuator attachment point and the lower end of the boom; and
wherein the electromechanical actuator comprises:
a first end that is pivotably connected to the mount about a mount-actuator pivot;
an opposing second end that is pivotably connected to the boom at the actuator attachment point; and
an electric motor configured in a first mode to convert electrical energy from the electric storage device into mechanical energy and in a second mode to convert mechanical energy into a quantity of recovered electrical energy;
wherein the electromechanical actuator is connected between the boom and the mount in a plane normal to an axis of rotation of the boom about the mount-boom pivot, wherein the plane extends between the two legs of the of the boom and wherein the electromechanical actuator is configured to extend and contract so as to effect rotation of the boom with respect the mount-boom pivot;
wherein the electric work machine further comprises a controller configured to control distribution of the quantity of energy recovered in the second mode by the electric motor to one or more of:
an electric storage assembly comprising the electric storage device;
one or more subsidiary electromechanical actuators; and
a load dissipator.

In this way, increased space for an electromechanical actuator is provided. This enables improved positioning of the electromechanical actuator for increasing efficiency of actuating the boom and energy recovery. This in turn improves the length of time for which an electromechanical actuator may be used on a single charge and/or otherwise increases the energy efficiency of the electric work machine.

In a second aspect of the disclosure, there is provided a method of controlling an electric work machine, the electric work machine comprising:
a work machine body comprising an electric storage device; and
a boom assembly comprising a mount, a boom and an electromechanical actuator, the mount being connected to the work machine body;
wherein the boom comprises:
an upper end configured to be connected to an arm;
a lower end that is pivotably connected to the mount about a mount-boom pivot;
an actuator attachment point located between the upper end and the lower end of the boom;
a bifurcated portion of the boom comprising two legs, the bifurcated portion extending between the actuator attachment point and the lower end of the boom; and
wherein the electromechanical actuator comprises:
a first end that is pivotably connected to the mount about a mount-actuator pivot;
an opposing second end that is pivotably connected to the boom at the actuator attachment point; and
an electric motor configured in a first mode to convert electrical energy from the electric storage device into mechanical energy and in a second mode to convert mechanical energy into a quantity of recovered electrical energy;
wherein the electromechanical actuator is connected between the boom and the mount in a plane normal to an axis of rotation of the boom about the mount-boom pivot, wherein the plane extends between the two legs of the of the boom and wherein the electromechanical actuator is configured to extend and contract so as to effect rotation of the boom with respect the mount-boom pivot;
wherein the method comprises controlling distribution of the quantity of energy recovered in the second mode by the electric motor to one or more of:
an electric storage assembly comprising the electric storage device;
one or more subsidiary electromechanical actuators; and
a load dissipator.

In this way, efficiency of the machine is improved.

### BRIEF DESCRIPTION OF THE DRAWINGS

By way of example only, embodiments according to the present disclosure are now described with reference to the following figures in which:

FIG. 1 shows an isometric view of an excavator comprising a boom assembly according to a first embodiment of the disclosure;

FIG. 2 shows a further isometric view of an excavator comprising a boom assembly according to a first embodiment of the disclosure;

FIG. 3 shows a side view of an excavator comprising a boom assembly according to a first embodiment of the disclosure;

FIG. 4 shows a front view of an excavator comprising a boom assembly according to a first embodiment of the disclosure;

FIG. 5 shows an isometric view of a boom of the first embodiment;

FIG. 6 shows a detailed isometric view of the boom assembly of the first embodiment;

FIG. 7 shows an isometric view of an excavator comprising a boom assembly according to a second embodiment of the disclosure;

FIG. 8 shows a further isometric view of an excavator comprising a boom assembly according to a second embodiment of the disclosure;

FIG. 9 shows an isometric view of a mini excavator comprising a boom assembly according to a third embodiment of the disclosure;

FIG. 10 shows a side view of a mini excavator comprising a boom assembly according to a third embodiment of the disclosure;

FIG. 11 shows a detailed view of a boom of the third embodiment;

FIG. 12 shows a detailed view of a boom according to a fourth embodiment of the disclosure;

FIG. 13 shows a detailed view of a boom according to a fourth embodiment of the disclosure; and

FIG. 14 shows an isometric view of an excavator comprising a boom assembly according to a fourth embodiment of the disclosure.

FIG. 15 shows an electric work machine according to the disclosure

FIG. 16 shows an energy distribution network indicating electrical and mechanical energy transfers which take place within an electric work machine.

FIG. 17 shows an example of an energy distribution hierarchy according to some embodiments of the disclosure.

FIG. 18 shows an example of a method for managing surplus energy according to some embodiments of the disclosure.

### DETAILED DESCRIPTION

According to one or more aspects of this disclosure, an electric work machine is provided. The electric work machine may be, for example, an excavator, a mini-excavator, a backhoe, and/or the like. The electric work machine comprises a work machine body and a boom assembly. The boom assembly may comprise a boom pivotally connected to a mount, a stick pivotably connected to the boom and a tool attachment portion pivotably connected to the stick. The mount may be connected to the work machine body. As such, movement of the boom, stick and tool attachment portion relative to one another, and movement of the boom assembly relative to the work machine body may be controlled in order to manipulate a tool connected to the tool attachment portion. The boom assembly comprises an electromechanical actuator for effecting movement of the boom relative to the work machine body.

In accordance with the disclosure, the electromechanical actuator may be used not only to convert electrical energy to mechanical energy (including kinetic energy and gravitational potential energy) in order to effect movement of the boom but also to convert mechanical energy to electrical energy, for example when the boom moves downwards. The electromechanical actuator may comprise an electric motor configured in a first mode to convert electrical energy from an electric storage device into mechanical energy and in a second mode to convert mechanical energy from the boom into electrical energy. The electric motor may be an AC motor. The electric storage device may comprise a battery and/or a rechargeable battery and/or a supercapacitor.

In the first mode, the electric motor may be configured to cause the first end and the second end of the electromechanical actuator to extend and/or contract with respect to each other. As noted previously, as the electromechanical actuator extends and/or contracts, the boom may be pivoted with respect to the work machine body. In this way, in the first mode, the electrical energy from the electric storage device may be converted into mechanical energy by the electromechanical actuator and provided to the boom. In the first mode, the net transfer of energy may be from the electromechanical actuator to the boom. As such, in some embodiments, operation of the electric motor in the first mode results in movement of the boom upwards.

In the second mode, a movement of the boom may cause the first end and the second end of the electromechanical actuator to extend and/or contract with respect to each other, which in turn results in a movement of the electric motor in the second mode. In this way, movement of the electric motor is effected by the extension and/or contraction of the electromechanical actuator, meaning the electric motor in the second mode acts as an electrical generator. In the second mode, the net transfer of energy may be from the boom to the electromechanical actuator. As such, in some embodiments, operation of the electric motor is the second mode results from movement of the boom downwards.

A raised boom may act as a store of gravitational potential energy. Similarly, a moving boom may act as a store of kinetic energy. A boom may therefore store mechanical energy. Mechanical energy may comprise kinetic energy and/or gravitational potential energy. The mechanical energy may be recovered by the electric motor configured in a second mode to convert mechanical energy into a quantity of recovered electrical energy. The mechanical energy of the boom may cause the electromechanical actuator to extend and/or contract, for example as the boom is lowered, and the extending and/or contracting of the electromechanical actuator may provide kinetic energy to the electric motor configured in the second mode. In this way, the mechanical energy from the boom may also be converted into a quantity of recovered electrical energy by the electromechanical actuator and utilised elsewhere in the electric work machine.

The electric work machine may comprise a controller configured to control distribution of the quantity of recovered electrical energy. For example, the controller may be configured to control distribution of the quantity of recovered electrical energy to one or more of an electric storage assembly comprising the electric storage device; one or more subsidiary electromechanical actuators; and a load dissipator.

As will become apparent to the skilled person by the below explanations, the efficiency of the above energy conversions is particularly aided by a boom assembly configured according to this disclosure. Various ways of configuring a boom assembly in accordance with this disclosure are set out in more detail below.

### Examples of a Boom Assembly in Accordance With This Disclosure

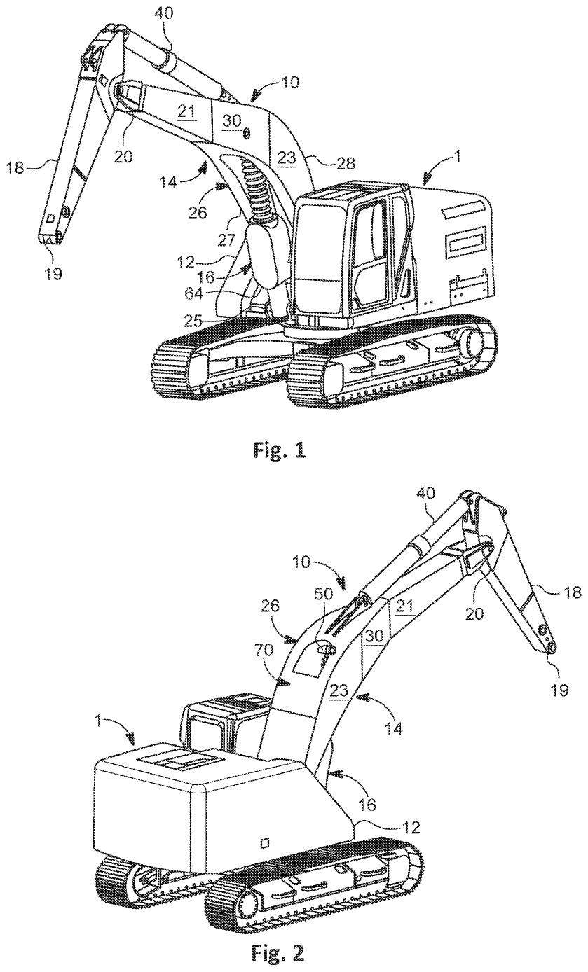

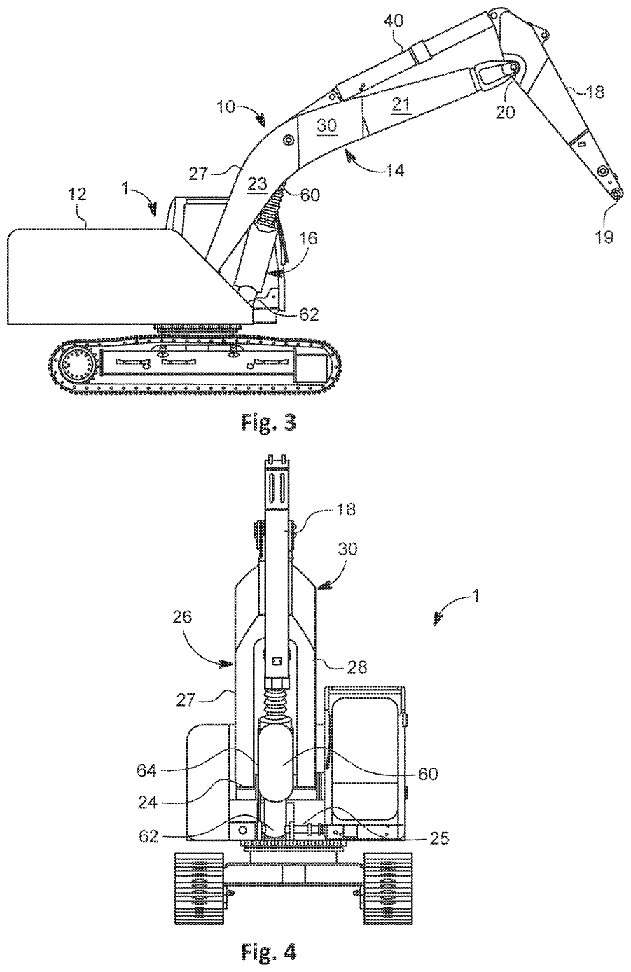

For example, FIG. 1 shows a diagram of an excavator 1 comprising a boom assembly 10 according to a first embodiment of the disclosure. As shown in FIG. 1, the boom assembly 10 comprises a mount 12, a boom 14, and an actuator 16. In the embodiment of FIG. 1, the mount 12 is provided by the chassis of the excavator 1. FIG. 1 shows an isometric front view of the excavator 1, while FIG. 2 shows an isometric rear view of the excavator 1. FIG. 3 shows a side view of the excavator 1, while FIG. 4 shows a front view of the excavator 1.

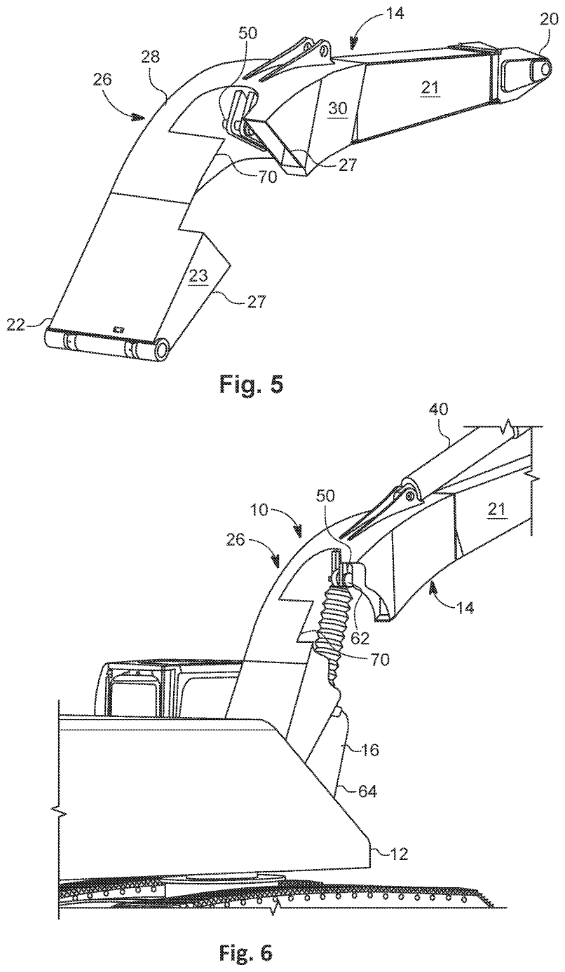

FIG. 5 shows a detailed view of the boom 14 of the first embodiment. The boom 14 of the excavator 1 has an upper end 20 and a lower end 22. The boom 14 of FIG. 5 may have an upper section 21 extending from the upper end 20 to an elbow section 30. The boom 14 may also have a lower section 23 extending from the elbow section 30 to the lower end 22. As shown in the side view of FIG. 3, the lower section 23 may extend from the lower end 22 in a generally linear manner (i.e. along an axis) towards the elbow section 30. The upper section 21 may extend from the upper end 20 in a generally linear manner towards the elbow section 30. The elbow section 30 of the boom 14 may define a bend of the boom 14 such that an obtuse angle of the boom is defined between the upper and lower sections of the boom 21, 23. As such, in a side view, the boom 14 of FIG. 5 may have a similar obtuse angled shape to booms known in the art.

The upper end 20 of the boom 14 is configured to be connected to an arm 18. In the embodiment of FIG. 1 the upper end 20 is connected to the arm 18 by a pivotable connection. The arm 18 may provide an attachment point 19 for a work tool (not shown) at an opposing end of the arm 18 to the pivotable connection to the boom 14. The work tool may, for example be a bucket or the like. The rotational position of the arm 18 relative to the boom 14 may be controlled by an arm actuator 40. The arm actuator 40 may be connected between the arm 18 and the boom 14. The arm actuator 40 may be a electromechanical actuator of a similar type to the electromechanical actuator 16 of the boom assembly 10.

The lower end 22 of the boom 14 is pivotably connected to the mount 12 at a mount-boom pivot 24. The boom 14 is configured to rotate about the mount-boom pivot 24. In the embodiment of FIG. 1, the mount-boom pivot 24 may extend along a first axis such that the boom rotates in a plane orthogonal to the first axis. In the embodiment of FIG. 1, the first axis may extend in a generally horizontal direction such that the boom 14 rotates about the mount-boom pivot 24 in a generally vertical plane.

As shown in FIG. 5, the boom 14 comprises a bifurcated portion 26. The bifurcated portion 26 extends between the lower end 22 of the boom 14 and the upper end 20 of the boom. In the embodiment of FIG. 5, the bifurcated portion 26 also extends between the lower end of the boom 14 and an actuator attachment point 50. In the embodiment of FIG. 5, the bifurcated portion 26 may extend along the boom 14 from the lower end 22 towards the upper end of the boom 14 beyond the actuator attachment point 50.

The bifurcated portion 26 comprises two legs 27, 28. As shown in FIG. 4, each leg 27, 28 extends from the lower end of the boom 22. As such, an end of each leg 27, 28 is pivotably connected to the mount 12. The two legs 27, 28 are spaced apart to define a void region between the two legs 27, 28. The void region between the two legs 27, 28 may be provided to accommodate at least a portion of the electromechanical actuator 16 during at least a portion of the movement arc of the boom assembly 10. That is to say, the electromechanical actuator 16 may move between the two legs 27, 28 as the boom 14 rotates about the mount-boom pivot 24.

Towards the upper end 20 of the boom 14, the two legs 27, 28 of the boom 14 join together. As such, the bifurcated portion 26 may extend only partially along the length of the boom. In the embodiment of FIGS. 1-5, the two legs 27, 28 join together at the elbow portion 30 of the boom. As such, the boom 14 including the bifurcated portion 26 defines a fork shape. That is to say, the boom 14 has a forked lower end comprising two legs 26, 27.

As shown in FIG. 4, an external width of the bifurcated portion 26 of the boom in a direction of the axis of rotation of the boom is greater than a width of the upper end 20 of the boom 14 in the direction of the axis of rotation of the boom 14. That is to say, the legs 27, 28 of the boom 14 are spaced apart such that they are wider (in a direction of the axis of rotation of the boom, which is a horizontal direction in FIG. 4) than the upper end of the boom 20. As shown in FIG. 4, the boom 14 widens at the elbow section 30 to accommodate the change in width of the boom. By widening the bifurcated section 26 of the boom 14, the legs 27, 28 may be provided with increased width, thereby increasing their torsional stiffness, whilst also providing a suitably wide void to accommodate the electromechanical actuator 16.

FIG. 5 shows a partial cross-section through one of the legs 27 to show the internal structure of the leg 27. As shown in FIG. 5, each leg 27, 28 of the bifurcated portion 26 may be formed from a box section. The box section structure of each leg 27, 28 extends along a length of the boom 14 between the lower end 22 and the elbow section 30. The box section of each leg 27, 28 provides torsional stiffness for the boom 14.

The boom 14 also includes the actuator attachment point 50. The actuator attachment point 50 provides point on the boom 14 where the electromechanical actuator 16 is pivotably connected to the boom 14. FIG. 6 provides a detailed view of the first embodiment showing the electromechanical actuator 16 pivotably connected to the boom 14 at the actuator attachment point 50.

In the embodiment of FIG. 1, the two legs 27, 28 of the bifurcated portion 26 may extend along the boom at least: 50, 60, 70, or 80 % of the distance along the boom 14 between the mount-boom pivot 24 at the lower end of the boom 22 and the actuator attachment point 50. In some embodiments, the bifurcated portion 26 may extend along all of the distance between the mount-boom pivot 24 at the lower end of the boom 22 and the actuator attachment point 50, for example as shown in FIG. 1.

In the first embodiment, the actuator attachment point 50 may be located between the legs 27, 28 of the bifurcated portion 26, for example as shown in FIGS. 2, 4, and 6 of the first embodiment. In other embodiments, as discussed in more detail below, the actuator attachment point 50 may be provided in other locations of the boom 14.

The electromechanical actuator 16 is provided to control/drive the rotational position of the boom 14 relative to the mount 12. Accordingly, a first end 60 of the electromechanical actuator 16 is pivotably connected to the mount 12 about a mount-actuator pivot 25. At an opposite end of the electromechanical actuator 16, a second end 62 is pivotably connected to the boom 14 at the actuator attachment point 50. The electromechanical actuator 16 is configured to provide a motive force in a linear direction in order to drive the rotational position of the boom 14.

The electromechanical actuator shown in FIG. 1 comprises a housing 64. The housing 64 houses the power electronics and motor used to generate the linear motion of the electromechanical actuator 16. The boom assembly 10 shown in FIG. 1 can accommodate the housing 64 of the electromechanical actuator through the provision of the void between the legs 27, 28 of the bifurcated portion 26.

In the first embodiment, only one electromechanical actuator 16 may be connected between the mount 12 and the boom 14 in order to control/drive the rotational position of the boom 14 relative to the mount 12. As such, the first embodiment provides a boom assembly 10 which can be driven by a single electromechanical actuator 16, rather than a plurality of electromechanical actuators. By mounting the electromechanical actuator 16 in a plane extending between the legs 27, 28, the boom 14 has improved torsional rigidity.

The electromechanical actuator 16 is pivotably connected between the mount 12 and boom 14 in a plane normal to an axis of rotation of the boom about the mount-boom pivot 25, wherein the plane extends between the two legs of the of the boom. As shown in FIG. 1, at least a portion of the electromechanical actuator 16 extends between the legs 26, 27 of the boom in the void provided by the bifurcated portion 26. Such a bifurcated portion allows a electromechanical actuator 16 to be accommodated by the boom 14 in a generally central position (between the legs 27, 28) whilst allowing the boom 14 to maintain a full range of rotational movement.

In the first embodiment, as shown in FIG. 4, the mount-actuator pivot 25 may be provided below the mount-boom pivot 24. As such, when the electromechanical actuator 16 is contracted, the upper end of the boom 20 is lowered relative to the mount 12. In other embodiments, the relative positions of the mount-boom pivot 24 and the mount-actuator pivot 25 may be different.

In some embodiments, a stiffening member 70 may be provided between the two legs 27, 28 of the bifurcated portion 26 to partially close a region of the bifurcated portion 26 between the two legs towards the lower end of the boom 22. As such, the lower section 23 of the boom 14 may have a whistle shape, wherein the bifurcated section 26 provides an opening between the two legs 27, 28 to accommodate the electromechanical actuator. The stiffening member 70 is provided on a top surface of the legs 27, 28 to provide additional torsional stiffness to the legs 27, 28. As shown in FIG. 4, the box sections of the legs 27, 28 extend between the elbow section 30 and the lower end 22 of the boom below the stiffening member 70.

The stiffening member 70 may close the bifurcated portion 26 along at least 20% of the length of the bifurcated portion in order to provide a suitable stiffening effect. The stiffening member may close the bifurcated portion along no more than 80% of the length of the bifurcated portion 26 in order to provide a suitable space to accommodate the electromechanical actuator 16.

In the embodiment of FIG. 4, the stiffening member 70 may comprise a plate. As such, the stiffening member 70 comprises a plate which extends across the void region of the bifurcated portion 26 between the two legs 27, 28. In other embodiments, the stiffening member 70 may comprise other forms/shapes. For example, in some embodiments, the stiffening member 70 may comprise a tube, or box section, running axially, between the legs 27, 28 (i.e. a central axis of the tube extends in a generally transverse direction to the legs 27, 28).

It will be appreciated that the first embodiment discussed above is only one possible example of a boom assembly 10 according to this disclosure. Various modifications and alternatives to the first embodiment discussed above will be apparent to the skilled person from the following discussion of further embodiments of this disclosure.

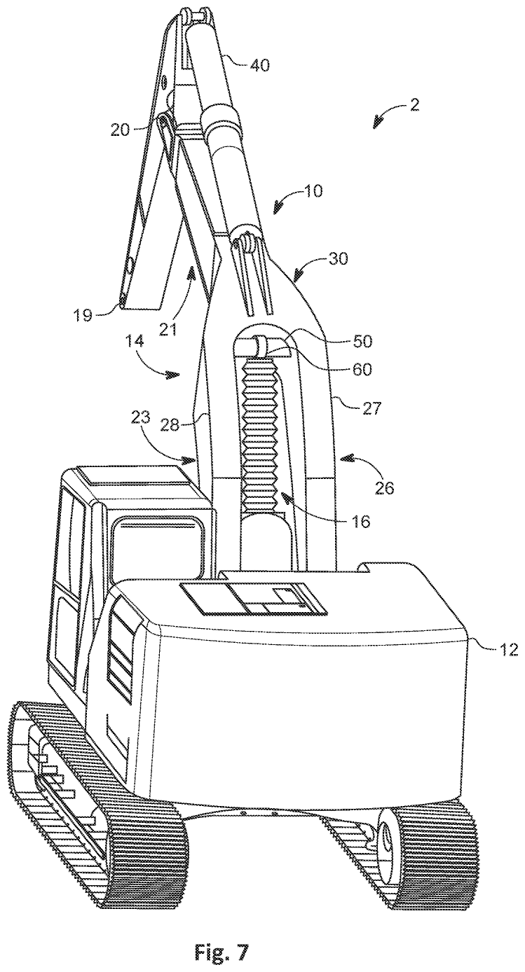

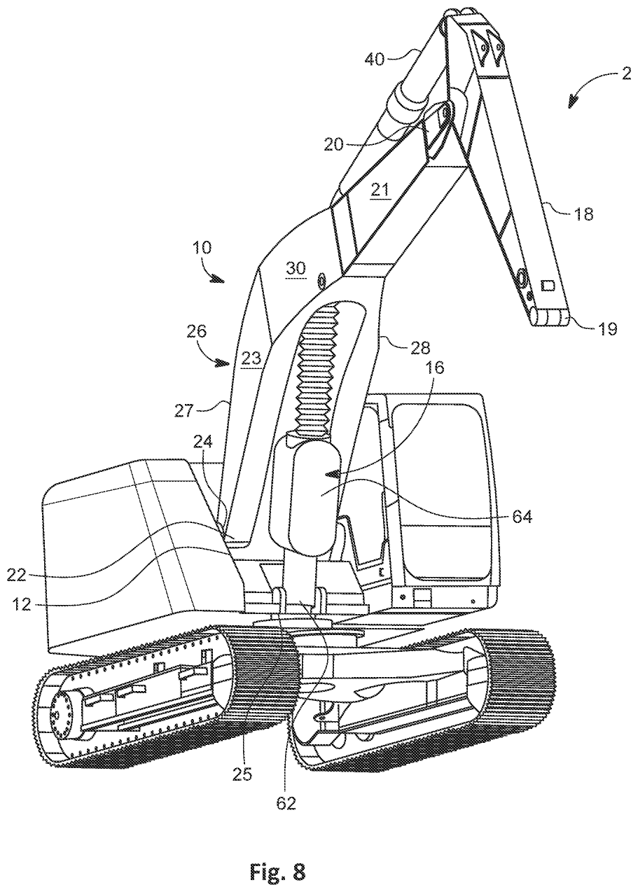

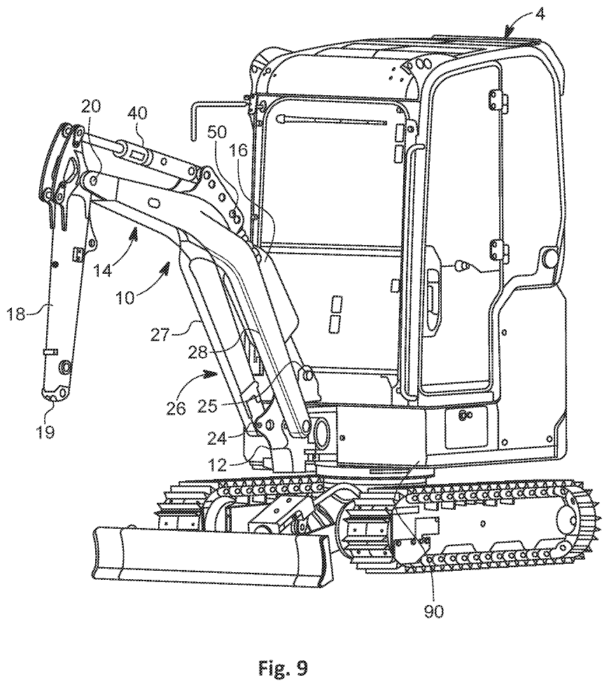

According to a second embodiment of the disclosure, an excavator 2 is provided. The excavator 2 is similar to the excavator of the first embodiment in that it comprises a boom assembly 10. FIG. 7 shows a rear isometric view of the excavator 2 of the second embodiment. FIG. 8 shows a front isometric view of the excavator 2 of the second embodiment.

The boom assembly 10 of the second embodiment has a generally similar construction to the first embodiment. The boom assembly of the second embodiment does not include a stiffening member 70 that partially closes a region of the bifurcated portion. As such, each of the two legs 27, 28 of the bifurcated portion extend from the elbow section 30 to the lower end of the boom 30 in a fork shape.

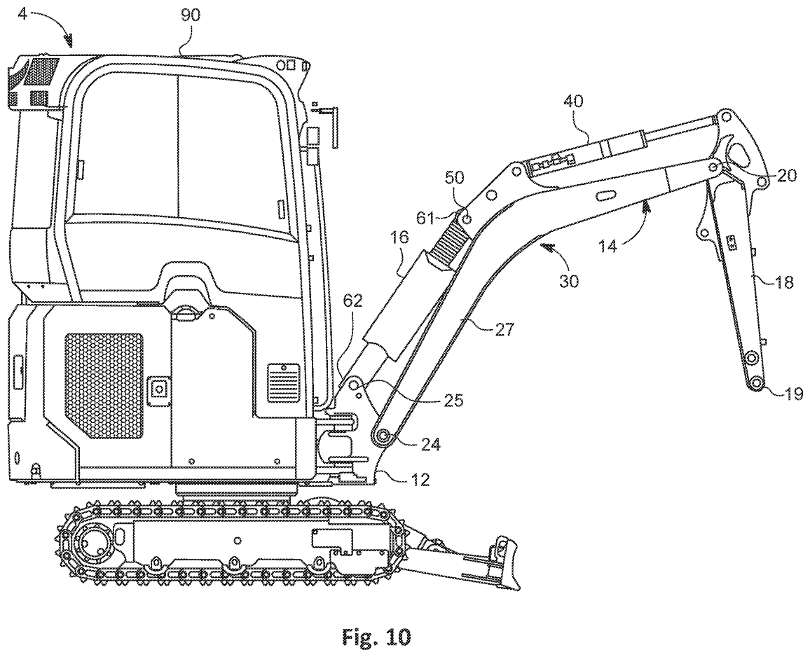

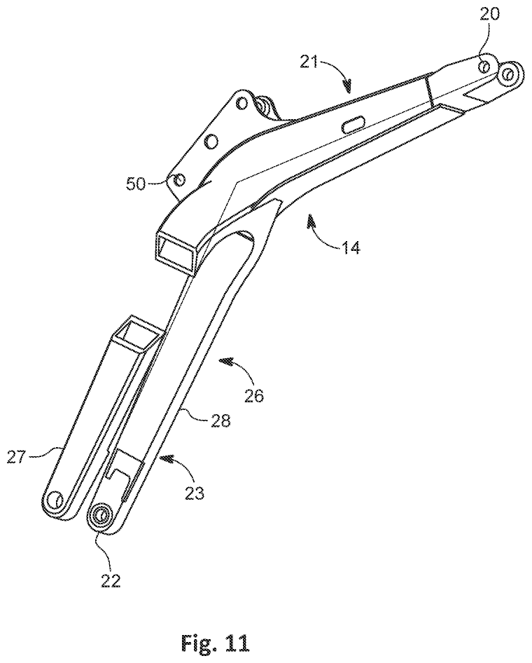

According to a third embodiment, a mini-excavator 4 is provided. FIG. 9 shows an isometric view of the mini-excavator 4 of the third embodiment. FIG. 10 shows a side view of the mini-excavator 4 of the third embodiment. FIG. 11 shows a detailed view of the boom 14 of the mini-excavator 4 of the third embodiment.

It will be appreciated from the third embodiment that the boom assembly 10 of embodiments of this disclosure may be used on variety of machines. The boom 14 of the third embodiment has a forked shape similar to the boom 14 of the second embodiment. The boom 14 and actuator 16 of the third embodiment are mounted to the mount 12 in a similar arrangement to the third embodiment. It will be appreciated that in other embodiments, a mini-excavator 4 may be provided with a mounting arrangement similar to the first and second embodiments. The boom 14 may also then be provided with a stiffening member similar to the first embodiment.

The mini-excavator 4 includes a mount 12 to which the boom 14 and the electromechanical actuator 16 are connected which is not the chassis of the machine. Rather, in the mini-excavator 4 the mount 12 provides an intermediate part between the boom 14 and the chassis 90 of the mini-excavator 4. The mount 12 of the mini-excavator may be configured to rotate the entire boom assembly 10 about a vertical axis relative to the chassis 90 of the mini-excavator 90.

The mini-excavator 4 shown in FIGS. 9 and 10 is provided with an electromechanical actuator 16. As such, it will be appreciated that the boom assembly of this disclosure may also be used to accommodate electromechanical actuators of a variety of different sizes on a range of different sized machines.

FIG. 11 shows a detailed view of the boom 14 of the third embodiment. It will be appreciated from FIG. 11 that the actuator attachment point 50 is located on the elbow section 30 of the boom 14. As such, in the third embodiment the bifurcated portion 26 of the boom may not extend the entire axial distance to the actuator attachment point 50. It will be appreciated from the embodiments of the disclosure that the extent to which the bifurcated portion 26 extends along the boom 14 towards the actuator attachment point 50, and the location of the actuator attachment point 50 will depend on the size of the electromechanical actuator 16 to be accommodated and the relative positions of the mount-boom pivot 24 and the mount-actuator pivot 25.

According to the first through third embodiments of the disclosure, the bifurcated portion 26 of the boom 14 may extend from the elbow section 30 to the lower end of the boom 14 such that two mount-boom pivot 24 connections are provided at the lower end 20, one for each leg 27, 28.

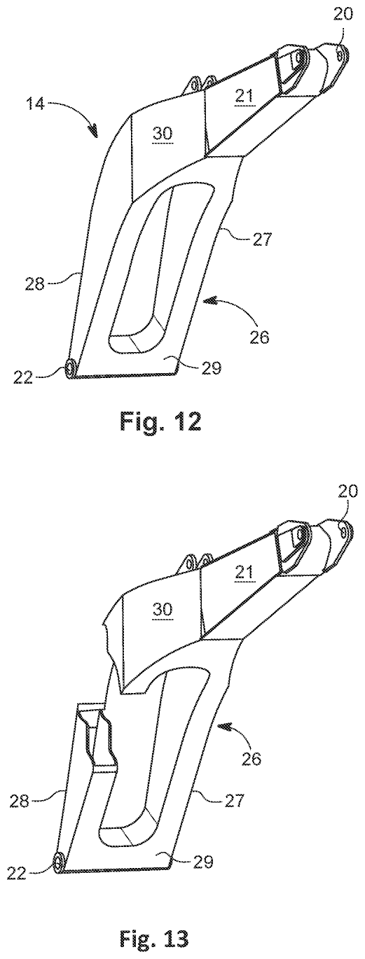

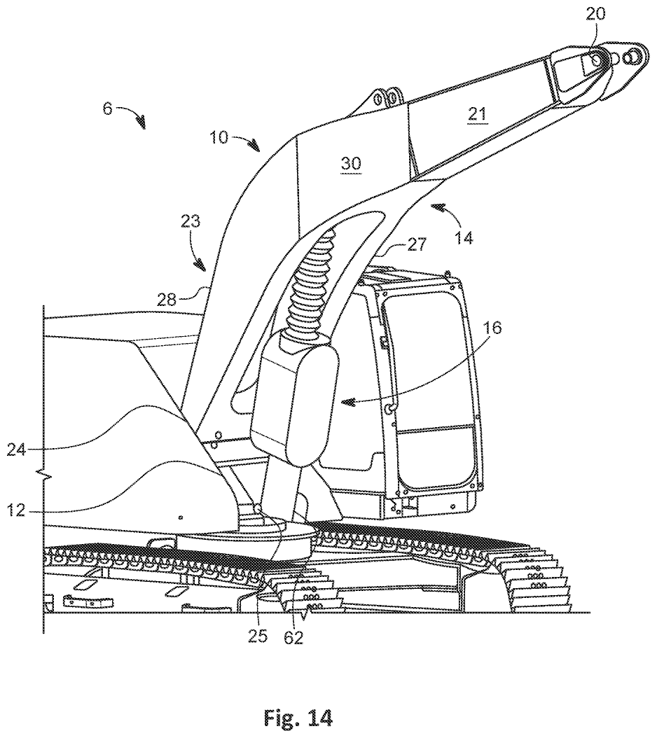

According to a fourth embodiment of the disclosure, a boom assembly 10 may be provided in which the bifurcated portion 26 may not extend completely to the lower end 22 of the boom 14. That is to say, the two legs 27, 28 join together at a lower portion 29 of the boom 14. An example of such a boom 14 is shown in FIGS. 12 and 13. An excavator 6 according to the fourth embodiment is shown in FIG. 14.

As such, rather than a forked shape, or a whistle shape, the lower section of the boom 23 forms an O-shape. In contrast to the whistle shaped embodiment where the box sections of the two legs do not meet towards the lower end 22, in the embodiment of FIG. 12, the box section of the two legs 27, 28 join at together at the elbow section 30 and at the lower section 29.

As shown in FIG. 14, the excavator 6 may be provided with a boom assembly 10 according to the fourth embodiment. In the fourth embodiment, the mount-boom pivot 24 may be provided above the mount-actuator pivot 25, similar to the first and second embodiments. It will be appreciated that the positions of the mount-boom and the mount-actuator pivot 25 may be reversed. Further, it will be appreciated that a mini-excavator may be provided with a boom assembly 10 having an O-shaped bifurcated portion 26.

### Recovery and Distribution of Energy

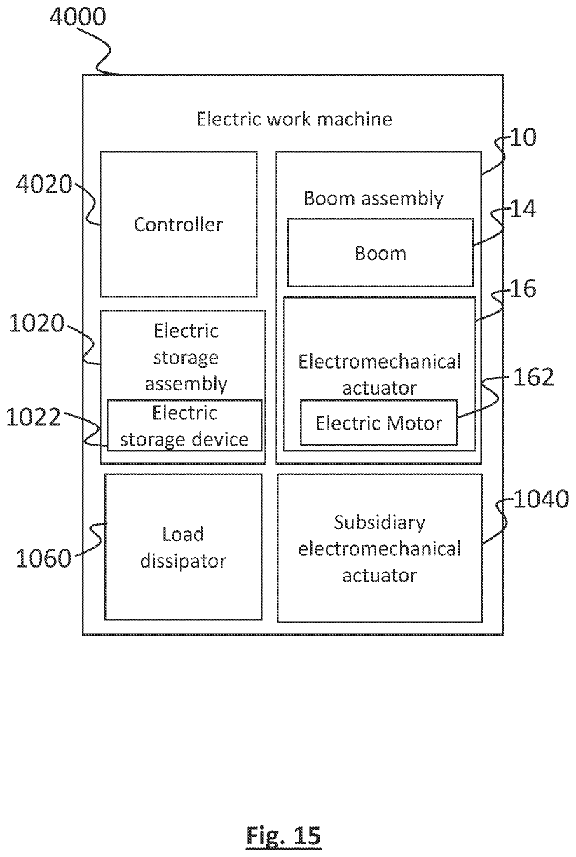

FIG. 15 shows an electric work machine 4000 according to the disclosure. The electric work machine 4000 comprises a boom assembly 10, an electric storage assembly 1020, a controller 4020, a load dissipator 1060, and one or more subsidiary electromechanically actuators 1040. The boom assembly 10 comprises a boom 14 and an electromechanical actuator 16. The electric storage assembly 1020 comprises an electric storage device 1022. The electric storage device may comprise a battery and/or a rechargeable battery and/or a supercapacitor. The electromechanical actuator 16 comprises an electric motor 162. The controller 4020 is configured to control distribution of energy in the work machine 4000. The controller 4020 is configured to control distribution of the quantity of recovered electrical energy in the second mode by the electric motor 162.

How the energy is distributed by the controller 4020 and according to which priorities is explained in more detail below.

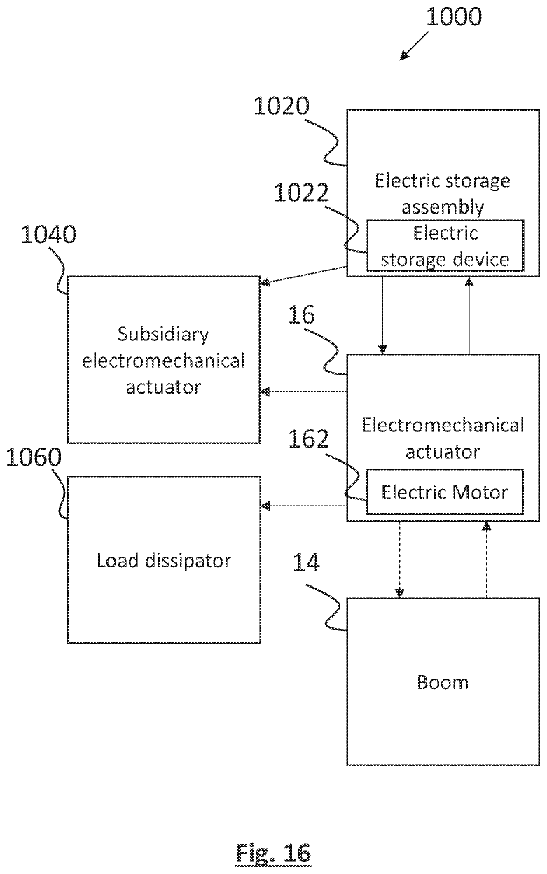

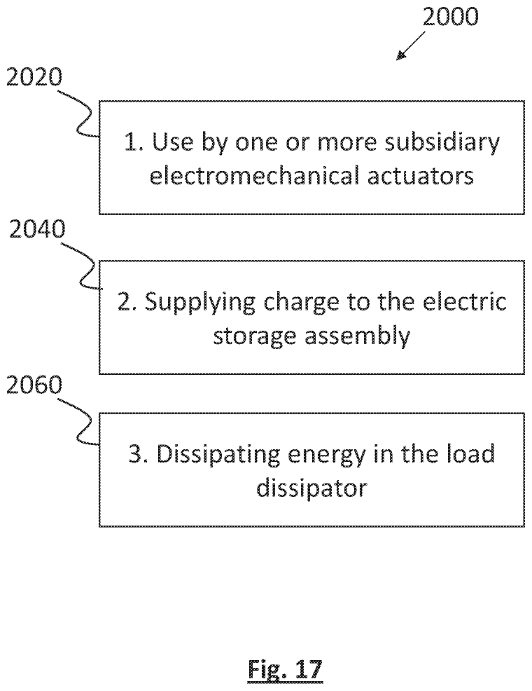

FIG. 16 shows an energy distribution network 1000 indicating electrical and mechanical energy transfers which take place within the electric work machine 4000. The solid line arrows indicate transfers of electrical energy and the broken line arrows indicate transfers of mechanical energy. None of the transfers are 100% efficient and other energy transfers, for example waste losses to heat may occur. The energy distribution network 1000 may comprise the electrical and mechanical components of the work machine 4000. The energy distribution network 1000 may comprise the electric storage assembly 1020, the electromechanical actuator 16, and the boom 14. In some embodiments, the electric storage assembly 1020 may comprise the electric storage device 1022. As has been explained above, the electric storage device 1022 may provide electrical energy to the electromechanical actuator 16. The electromechanical actuator 16 may convert the electrical energy into mechanical energy using the electric motor 162 operating in the first mode. The mechanical energy may be transferred to the boom 14, causing the boom to pivot about the mount-boom pivot. As has also been explained above, the mechanical energy from the boom 14 may then be transferred back to the electromechanical actuator 16 and converted into electrical energy by the electric motor 162 operating in the second mode. In this way, mechanical energy provided to the boom 14 can be recovered into a quantity of recovered electrical energy by the electric motor 162. The quantity of recovered electrical energy is then available for distribution to the rest of the energy distribution network 1000.

Some options for distributing the quantity of recovered electrical energy will now be explained with reference to FIG. 16. The quantity of recovered electrical energy may be provided to charge the electric storage assembly 1020. For example, the electric storage device 1022 of the electric storage assembly 1020 may be recharged by the quantity of recovered electrical energy. In this way, the quantity of recovered electrical energy can be stored. In some embodiments, the quantity of recovered electrical energy may be transferred to a subsidiary electromechanical actuator 1040. In some embodiments, the quantity of recovered electrical energy may be provided to one or more subsidiary electromechanical actuators 1040. The one or more subsidiary electromechanical actuators 1040 may be provided, for example, to actuate the stick with respect to the boom, or tool attachment portion with respect to the stick. The one or more subsidiary electromechanical actuators 1040 may be configured in much the same way as the electromechanical actuator 16. In some embodiments, the quantity of recovered electrical energy may be transferred to the one or more subsidiary electromechanical actuators 1040 directly. In some embodiments, the quantity of recovered electrical energy may be stored in the electric storage assembly 1020 and later transferred to the one or more subsidiary electromechanical actuators 1040. The quantity of recovered electrical energy may be provided to any other electrical device carrying out useful tasks, for example lighting, an onboard computer, or onboard climate control. In some embodiments, the quantity of recovered electrical energy may be transferred to a load dissipator 1060. For example, the quantity of recovered electrical energy may be dissipated as heat by the load dissipator 1060.

The above options for distributing the quantity of recovered electrical energy may be prioritised in accordance with an energy distribution hierarchy. FIG. 17 shows an example of an energy distribution hierarchy 2000 according to certain embodiments of the disclosure. In some embodiments, the controller 4020 may be configured to distribute the quantity of energy recovered in the second mode in accordance with the energy distribution hierarchy 2000, where the energy distribution hierarchy 2000 defines the energy distribution priorities, from the most important to the least important. The first priority 2020 may be to use the quantity of recovered electrical energy by the one or more subsidiary electromechanical actuators 1040. The second priority 2040 may be supplying charge to the electric storage assembly 1020. For example, the second priority 2040 may involve transferring the quantity of recovered electrical energy to the electric storage assembly 1020. The quantity of recovered electrical energy may be used to charge the electric storage device 1022. The third priority 2060 may be dissipating the quantity of recovered electrical energy in the load dissipator 1060.

In some embodiments, the controller 4020 may be configured to distribute the quantity of energy recovered in the second mode in accordance with the energy distribution hierarchy 2000 by carrying out the following steps.

First, if the quantity of recovered electrical energy is greater than zero, the controller 4020 may distribute the recovered electrical energy according to the first priority 2020. The controller 4020 may determine if there is an immediate energy demand from the one or more subsidiary electromechanical actuators 1040. If the immediate energy demand is present, the controller may transfer as much of the quantity of recovered electrical energy as possible to the one or more subsidiary electromechanical actuators 1040. The controller 4020 may determine whether the immediate energy demand is less than the quantity of recovered electrical energy. For example, the controller 4020 may determine a first quantity of remaining electrical energy E(1^{st} remaining) from the immediate energy demand E(Demand) and the quantity of recovered electrical energy E(Recovered) by the following equation:

E(1^{st} remaining)=E(Recovered)−E(Demand)

If the first quantity of remaining electrical energy E(1^{st} remaining) is greater than zero, this may indicate that not all of the recovered electrical energy can be used by the one or more subsidiary electromechanical actuators 1040. In this case, a first quantity of remaining electrical energy will be available to distribute in accordance with the second priority 2040.

Second, as discussed above, if the first quantity of remaining electrical energy E(1^{st} remaining) is greater than zero, the controller 4020 may distribute the first quantity of remaining electrical energy according to the second priority 2040. The controller 4020 may determine the quantity of storable electrical by determining the difference between a current state of charge and a target state of charge of the electric storage assembly 1020. In some embodiments, the target state of charge of the electric storage assembly may be the maximum state of charge. If the electric storage assembly 1020 can store more energy, for example if the current state of charge is below the target state of charge, the controller may transfer as much of the first quantity of remaining electrical energy as possible to the electric storage assembly 1020. For example the controller may transfer the storable quantity of electrical energy. The controller may determine whether the quantity of additional electrical energy required by the electric storage assembly 1020 can store is less than the first quantity of remaining electrical energy. For example, the controller 4020 may determine a second quantity of remaining electrical energy E(2^{nd} remaining) from the quantity of additional electrical energy required by the electric storage assembly E(Storable) and the first quantity of remaining electrical energy E(1^{st} remaining) by the following equation:

E(2^{nd} remaining)=E(1^{st} remaining)−E(Storable)

If the second quantity of remaining electrical energy E(2^{nd} remaining) is greater than zero, this may indicate that not all of the first quantity of remaining electrical energy can be stored by the electric storage assembly 1020. In this case, a second quantity of remaining electrical energy will be available to distribute in accordance with the third priority 4060.

Third, if the second quantity of remaining electrical energy E(2^{nd} remaining) is greater than zero, the controller 4020 may distribute the second quantity of remaining electrical energy according to the third priority 2060. The controller may transfer the second quantity of remaining electrical energy to the load dissipator 1060.

The load dissipator 1060 may not be able to dissipate all of the second quantity of remaining electrical energy. Therefore, in some embodiments, the controller 4020 may determine a quantity of electrical energy deployable by the load dissipator 1060. If the quantity electrical energy deployable by the load dissipator 1060 is less than the second quantity of remaining electrical energy, a situation where the controller 4020 is unable to distribute the quantity of recovered electrical energy may be present. Such a situation may cause damage to components of the electric work machine because there may be electrical energy which cannot be transferred according to any of the priorities 2020, 2040, 2060 in the energy distribution hierarchy 2000. In this situation, there may be a quantity of surplus electrical energy corresponding to the difference between the second quantity of remaining electrical energy and a quantity of electrical energy deployable by the load dissipator 1060.

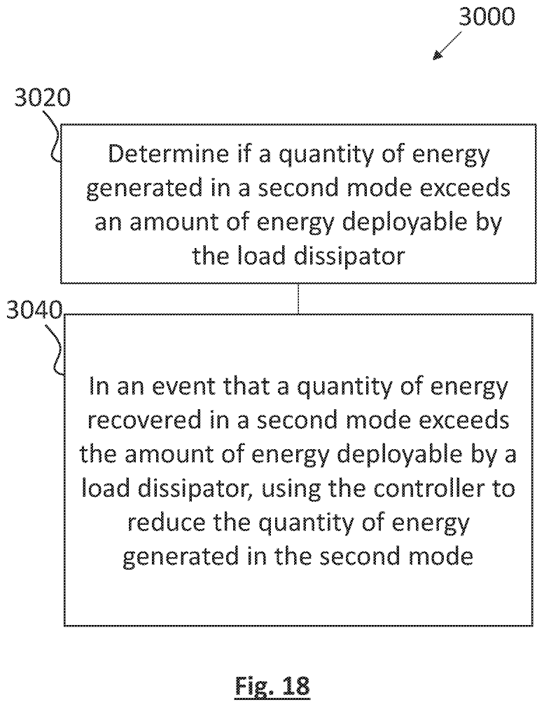

FIG. 18 shows an example of a method 3000 for managing the quantity of surplus electrical energy according to some embodiments of the disclosure. The controller 4020 may be further configured to, in a first step 3020 to determine if the quantity of energy generated in the second mode exceeds a quantity of energy deployable by the load dissipator 1060. In some embodiments the controller 4020 may be configured to determine if the quantity of energy generated in the second mode exceeds a quantity of energy deployable by the load dissipator 1060 by determining the quantity of surplus electrical energy E(Surplus) from the second quantity of remaining electrical energy E(2^{nd} remaining) and the quantity of energy deployable by the load dissipator E(Deployable) by the following equation:

E(Surplus)=E(2^{nd} remaining)−E(Surplus)

If the quantity of surplus electrical energy E(Surplus) is greater than zero, this may indicate that there may be electrical energy which cannot be transferred according to any of the priorities 2020, 2040, 2060 in the energy distribution hierarchy. If E(Surplus) is greater than zero, the controller 4020 in a second step 3040 to reduce the quantity of energy generated in the second mode. In some embodiments, reducing the quantity of energy generated in the second mode may comprise using the controller 4020 to cause a brake to be applied to arrest the motion of the boom 14. In this way, the brake may convert the mechanical energy from the boom 14 into heat.

In some embodiments, the electric storage assembly 1020 may comprise an onboard electric storage assembly and further comprise an offboard electric storage assembly. Both the onboard electric storage assembly and the offboard electric storage assembly may comprise one or more batteries and/or supercapacitors and/or capacitors and/or rechargeable batteries for storing electrical energy. A capacitor may be used for more rapid charging and release of charge than a battery. A supercapacitor may be used as an alternative to a rechargeable battery. A supercapacitor may store more electrical energy than a capacitor and tolerate more charge and discharge cycles than an electrolytic capacitor. The electric work machine 4000 may comprise at least one electric storage device 1022 provided either onboard or offboard for transferring electrical energy to the electromechanical actuator 16.

In embodiments where the electric storage assembly 1020 comprises an onboard electric storage assembly and an offboard electric storage assembly, the second priority 2040 of the energy distribution hierarchy 2000 may comprise the following sub priorities. The first sub priority of the second priority 2040 may be supplying charge to the onboard electric storage assembly. The second sub priority of the second priority 2040 may be supplying charge to the offboard electric storage assembly. The controller 4020 may be configured to transfer the first quantity of remaining electrical energy as much as possible to the onboard electric storage assembly, for example until a target state of charge of the onboard electric storage assembly is reached. The controller may be configured to transfer any remaining electrical energy to the offboard electric storage assembly, for example until a target state of charge of the offboard electric storage assembly is reached. If not all of the first quantity of remaining electrical energy can be used by charging the onboard electric storage assembly or the offboard electric storage assembly, as discussed previously, there may be a second quantity of remaining electrical energy which may be distributed by the controller 4020 in accordance with to the third priority 2060.

In some embodiments, the load dissipator 1060 may comprise an onboard load dissipator and an offboard load dissipator. In embodiments where the load dissipator 1060 comprises an onboard load dissipator and an offboard load dissipator, the third priority 2060 of the energy distribution hierarchy 2000 may comprise the following sub priorities. The first sub priority of the third priority 2060 may be dissipating electrical energy in the onboard load dissipator. The second sub priority of the third priority 2060 may be dissipating electrical energy in the offboard load dissipator. The controller 4020 may be configured to transfer the first quantity of remaining electrical energy as much as possible to the onboard load dissipator. The controller may be configured to transfer any remaining electrical energy to the offboard load dissipator. If not all of the second quantity of remaining electrical energy is deployable by the onboard load dissipator or the offboard load dissipator, as discussed previously, there may be a quantity of surplus electrical energy. The controller may be configured to carry out the method 3000 to reduce the quantity of surplus electrical energy.

In any of the above embodiments, any of the load dissipator 1060, the onboard load dissipator, and the offboard load dissipator may comprise one or more of: a heating device; a cooling device; a hydraulic device; or a braking device. The controller may be configured to deploy energy to the heating device in an event of a request for heat. The controller may be configured to deploy energy to the cooling device in an event of a request for cooling. The controller may be configured to deploy energy to the hydraulic device and/or to the braking device in an event of no request for heat and no request for cooling.

### INDUSTRIAL APPLICABILITY

According to embodiments of this disclosure, an electric work machine is provided. The electric work machine comprises a boom assembly. Various applications of the boom assembly are set out below.

The boom assembly of the first aspect provides a boom having a bifurcated portion. The bifurcated portion provides space for the electromechanical actuator to be mounted to the boom and mount. Mounting the electromechanical actuator between the two legs of the bifurcated portion of the boom reduces the torsional forces acting on the boom with respect to mounting the electromechanical actuator at one side of a non-bifurcated boom.

The bifurcation in the boom may also allow the electromechanical actuator to move between the two legs of the boom during movement of the boom. As such, the bifurcated portion of the boom may be configured to allow the actuator to pass between the two legs during at least a portion of the movement arc of the boom as it pivots about the mount. As such, the boom assembly of the first aspect may provide for an increased movement arc of the boom with respect to the mount.

The bifurcated portion of the boom defines a region in which the packaging for the electromechanical actuator may extend/be located during the movement range of the boom assembly (i.e. as the boom is raised or lowered with respect to the mount). For some electromechanical actuators, the packaging of the electromechanical actuator may be relatively large in diameter relative to the actuated piston rod. The bifurcated portion of the boom may define a region to accommodate the increased packaging size of an electromechanical actuator throughout the range of motion of the boom assembly.

Thus, a boom configured according to this disclosure provides additional space for the electromechanical actuator. The additional space for the electromechanical actuator allows for an improved positioning of the electromechanical actuator for providing mechanical forces to move the boom and for recovering energy from the boom. For example, by providing a bifurcated portion of the boom, a single, larger, centrally positioned electromechanical actuator may be used. By comparison, for a boom without a bifurcated portion, a pair of smaller electromechanical actuators may typically be used on the sides of the boom. By reducing the number of electromechanical actuators and/or by increasing their size, gains in efficiency of energy transfer between electrical and mechanical energy are made.

1. An electric work machine comprising:
a work machine body comprising an electric storage device; and
a boom assembly comprising a mount, a boom and an electromechanical actuator, the mount being connected to the work machine body;
wherein the boom comprises:
an upper end configured to be connected to an arm;
a lower end that is pivotably connected to the mount about a mount-boom pivot;
an actuator attachment point located between the upper end and the lower end of the boom;
a bifurcated portion of the boom comprising two legs, the bifurcated portion extending between the actuator attachment point and the lower end of the boom; and
wherein the electromechanical actuator comprises:
a first end that is pivotably connected to the mount about a mount-actuator pivot;
an opposing second end that is pivotably connected to the boom at the actuator attachment point; and
an electric motor configured in a first mode to convert electrical energy from the electric storage device into mechanical energy and in a second mode to convert mechanical energy into a quantity of recovered electrical energy;
wherein the electromechanical actuator is connected between the boom and the mount in a plane normal to an axis of rotation of the boom about the mount-boom pivot, wherein the plane extends between the two legs of the of the boom and wherein the electromechanical actuator is configured to extend and contract so as to effect rotation of the boom with respect the mount-boom pivot;
wherein the electric work machine further comprises a controller configured to control distribution of the quantity of recovered electrical energy in the second mode by the electric motor to one or more of:
an electric storage assembly comprising the electric storage device;
one or more subsidiary electromechanical actuators; and
a load dissipator.

2. The electric work machine according to claim 1, wherein the controller is configured to distribute the quantity of energy recovered in the second mode in accordance with the following hierarchy:
use by the one or more subsidiary electromechanical actuators;
supplying charge to the electric storage assembly;
dissipating energy in the load dissipator.

3. The electric work machine according to claim 1, wherein the electric storage assembly comprises an onboard electric storage assembly and an offboard electric storage assembly and wherein the controller is further configured to distribute the quantity of energy recovered in the second mode in accordance with the following hierarchy:
supplying charge to the onboard electric storage assembly;
supplying charge to the offboard electric storage assembly.

4. The electric work machine according to claim 1 wherein the load dissipator comprises one or more of:
a heating device;
a cooling device;
a hydraulic device;
a braking device;
and to deploy energy to the heating device in an event of a request for heat;
to deploy energy to the cooling device in an event of a request for cooling; and
to deploy energy to the hydraulic device and/or to the braking device in an event of no request for heat and no request for cooling.

5. The electric work machine according to claim 1, wherein the controller is further configured:
to determine if the quantity of energy generated in the second mode exceeds an amount of energy deployable by the load dissipator; and
in an event that the quantity of energy recovered in the second mode exceeds the amount of energy deployable by the load dissipator, using the controller to reduce the quantity of energy generated in the second mode.

6. The electric work machine according to claim 1, wherein
operation of the electric motor in the first mode results in movement of the boom upwards; and
operation of the electric motor is the second mode results from movement of the boom downwards.

7. The electric work machine according to claim 1, wherein an external width of the bifurcated portion of the boom in a direction of the axis of rotation of the boom is greater than a width of the upper end of the boom in the direction of the axis of rotation of the boom.

8. The electric work machine according to claim 1, wherein the electromechanical actuator is connected between the mount and the boom such that the electromechanical actuator extends between the two legs of the bifurcated portion of the boom.

9. The electric work machine according to claim 1, wherein the mount-actuator pivot is provided below the mount-boom pivot such that lowering the upper end of the boom causes the electromechanical actuator to contract.

10. The electric work machine according to claim 1, wherein the mount-actuator pivot is provided above the mount-boom pivot such that lowering the upper end of the boom causes the electromechanical actuator to extend.

11. The electric work machine according to claim 1, wherein
the two legs of the bifurcated portion of the boom extend along the boom at least: 50, 60, 70, or 80 % of the distance along the boom between the mount-boom pivot and the actuator attachment point.

12. The electric work machine according to claim 1, wherein
a stiffening member is provided between the two legs to partially close a region of the bifurcated portion between the two legs towards the lower end of the boom.

13. The electric work machine according to claim 1, wherein
only one electromechanical actuator configured to control the rotational position of the boom is connected between the mount and the boom.

14. The electric work machine according to claim 1, wherein
each leg of the bifurcated portion comprises a box section extending along the boom.

15. The electric work machine according to claim 1, wherein
the two legs of the bifurcated portion of the boom extends along the boom beyond the actuator attachment point such that the actuator attachment point is provided between the two legs of the bifurcated portion.

16. The electric work machine according to claim 1, wherein
the two legs of the bifurcated portion of the boom join together at a point along the boom between the bifurcated portion of the boom and the actuator attachment point.

17. The electric work machine according to claim 1, wherein
the two legs of the bifurcated portion of the boom extend to the mount-boom pivot such that each leg is pivotably connected to the mount.

18. The electric work machine according to claim 1, wherein
the two legs of the bifurcated portion of the boom join at a point along the boom towards the lower end such that the lower end of the boom is pivotably connected to the mount-boom pivot by a single pivotable connection.

19. A method of controlling an electric work machine, the electric work machine comprising:
a work machine body comprising an electric storage device; and
a boom assembly comprising a mount, a boom and an electromechanical actuator the mount being connected to the work machine body;
wherein the boom comprises:
an upper end configured to be connected to an arm;
a lower end that is pivotably connected to the mount about a mount-boom pivot;
an actuator attachment point located between the upper end and the lower end of the boom;
a bifurcated portion of the boom comprising two legs, the bifurcated portion extending between the actuator attachment point and the lower end of the boom; and
wherein the electromechanical actuator comprises:
a first end that is pivotably connected to the mount about a mount-actuator pivot;
an opposing second end that is pivotably connected to the boom at the actuator attachment point; and
an electric motor configured in a first mode to convert electrical energy from the electric storage device into mechanical energy and in a second mode to convert mechanical energy into a quantity of recovered electrical energy; wherein
wherein the electromechanical actuator is connected between the boom and the mount in a plane normal to an axis of rotation of the boom about the mount-boom pivot, wherein the plane extends between the two legs of the of the boom and wherein the electromechanical actuator is configured to extend and contract so as to effect rotation of the boom with respect the mount-boom pivot;
wherein the method comprises controlling distribution of the quantity of recovered electrical energy in the second mode by the electric motor to one or more of:
an electric storage assembly the electric storage device;
one or more subsidiary electromechanical actuators; and
a load dissipator.

20. The method of claim 19 further comprising controlling distribution of the quantity of energy recovered in the second mode in accordance with the following hierarchy:
use by the one or more subsidiary electromechanical actuators;
supplying charge to the electric storage assembly;
dissipating energy in the load dissipator.
